(19) United States
(12) Patent Application Publication
(10) Pub. No.: US 2022/0141237 A1
(43) Pub. Date: May 5, 2022

(54) DETECTION OF ABNORMAL OR MALICIOUS ACTIVITY IN POINT-TO-POINT OR PACKET-SWITCHED NETWORKS

(71) Applicant: BAE Systems Information and Electronic Systems Integration Inc., Nashua, NH (US)

(72) Inventors: Richard J. Ferguson, Bealeton, VA (US); Michael Bear, Falls Church, VA (US); Sumit Ray, Broadlands, VA (US); Jeannine Robertazzi, Crozet, VA (US); Daniel L. Stanley, Warrenton, VA (US)

(73) Assignee: BAE Systems Information and Electronic Systems Integration Inc., Nashua, NH (US)

(21) Appl. No.: 17/090,275

(22) Filed: Nov. 5, 2020

(51) Int. Cl. H04L 29/06; H04L 29/08

(52) U.S. Cl. CPC H04L 63/1416; H04L 63/1441; H04L 63/1425; H04L 69/324

(57) ABSTRACT

A method of detecting abnormal or malicious activity in a point-to-point or packet-switched data communication network includes tapping a link in the network to obtain a data stream transmitted from a node of the network in parallel with transmission of the data stream through the network. The tap is non-invasive because it does not interfere with the normal traversal of the data stream across the network. This is useful for certain applications, such as mission-critical systems, where it is desirable to monitor the network and inspect the data without adversely impacting or otherwise interfering with the normal operation of the system. The method further includes decoding a communication protocol encoded in the data stream to obtain payload data from the data stream, analyzing the payload data to detect abnormal or malicious activity, and notifying a host of the network of the detected abnormal or malicious activity in the payload data.

### STATEMENT OF GOVERNMENT INTEREST

This invention was made with United States government assistance. The United States government has certain rights in the invention.

### FIELD OF THE DISCLOSURE

This disclosure relates generally to data communications, and more particularly, to techniques for detecting abnormal or malicious activity in point-to-point or packet-switched data communication networks.

### BACKGROUND

SpaceWire is an example of a point-to-point communication network based in part on the IEEE 1355 communications standard. SpaceWire is often used onboard spacecraft to connect instruments, sensors, processors, memories, downlink telemetry, and in other spacecraft sub-systems. Nodes in the network can be connected through point-to-point links and by using worm-hole routing switches for routing packets across the network. Each link is a full-duplex, bi-directional serial data link which can operate at data rates from 2 megabits per second to 200 megabits per second. The point-to-point links are asynchronous, which allows for simple, low-cost implementations. These signals are driven across the link using Low Voltage Differential Signaling (LVDS), which requires two wires for each signal. Because typical SpaceWire implementations use simple point-to-point links, there are no existing provisions in the network for detecting abnormal or malicious activity, such as when a rogue actor takes control of a data payload. Therefore, there is a need to monitor the network for such abnormal or malicious activity in such vulnerable communication networks, without interfering with or otherwise impeding communications.

### BRIEF DESCRIPTION OF THE DRAWINGS

FIG. 1 is a block diagram of an example platform, in accordance with an embodiment of the present disclosure.

FIG. 2 is a logic flow diagram representing an example use case for a network monitor, in accordance with an embodiment of the present disclosure.

FIG. 3 is a data flow diagram of an example operation of the system for detecting abnormal or malicious activity in a data communication network, in accordance with an embodiment of the present disclosure.

FIG. 4 is a flow diagram of an example method for detecting abnormal or malicious activity in a point-to-point or packet-switched data communication network, in accordance with an embodiment of the present disclosure.

FIG. 5 is a block diagram of an example link tap, in accordance with an embodiment of the present disclosure.

FIG. 6 is a block diagram of an example network monitor, in accordance with an embodiment of the present disclosure.

FIG. 7 is a flow diagram of an example state machine representing operation of a

SpaceWire network, in accordance with an embodiment of the present disclosure.

FIG. 8 is a flow diagram of an example state machine representing operation of a method for non-invasively tapping a data communication network and analyzing a data stream to detect any anomalous or malicious activity, in accordance with an embodiment of the present disclosure.

FIG. 9 is a block diagram of an example processing platform that can be used in conjunction with the techniques as variously disclosed herein, in accordance with some embodiments of the present disclosure.

### DETAILED DESCRIPTION

Techniques are disclosed for detecting abnormal or malicious activity in a point-to-point or packet-switched data communication network. In an example embodiment, a methodology implementing the techniques includes tapping a link in the network to obtain a data stream transmitted from a node of the network in parallel with transmission of the data stream through the network. The tap is non-invasive in that it does not interfere with the normal traversal of the data stream across the network. This is useful for certain applications, such as mission-critical systems, where it is desirable to monitor the network and inspect the data without adversely impacting or otherwise interfering with the normal operation of the system, unless and until abnormal or malicious activity is detected. The method further includes decoding a communication protocol encoded in the data stream to obtain payload data from the data stream, analyzing the payload data to detect abnormal or malicious activity, and taking a remedial action, such as notifying a host of the network of the detected abnormal or malicious activity in the payload data and/or sending the payload data to the host for further analysis. Numerous embodiments and variations will be appreciated.

### General Overview

As noted above, there are some communication systems that are vulnerable to malicious attack, such as when a rogue actor takes control of a data payload. However, there are no existing provisions for detecting such malicious activity, particularly in a non-invasive manner that does not adversely affect the normal operation of the system.

To this end, an embodiment of the present disclosure includes non-invasively tapping a link in a data communication network to obtain a separate, logical copy of a data stream and analyzing the logical copy of the data stream to detect any anomalous or malicious activity. Upon detection of anomalous or malicious behavior, a trusted host platform is notified to respond to the activity. Suspect data can be downloaded for further inspection and analysis. In some such embodiments, a monitor analysis algorithm is implemented in executable code uploaded from the trusted host platform. One example data communication network is SpaceWire, although the disclosed techniques can be implemented in other point-to-point or packet-switched data communication networks. SpaceWire covers two of the seven layers of the Open Systems Interconnection (OSI) model for communications, including the physical and data-link layers. In some embodiments, a link at the physical layer is tapped non-invasively to obtain a logical copy of the data stream. In this manner, normal operation of the network is not affected. In at least some such embodiments, a network link flows between a payload and a payload monitor. The payload monitor taps the network link and feeds a unidirectional data stream to a network monitor. The network monitor organizes and analyzes the data stream for deviations from an expected behavior. The network monitor notifies the host of any deviations that are detected. Such an approach is non-invasive and does not impact the existing communication network. Should a failure occur, it would not impact other links in the system.

### Example Platform

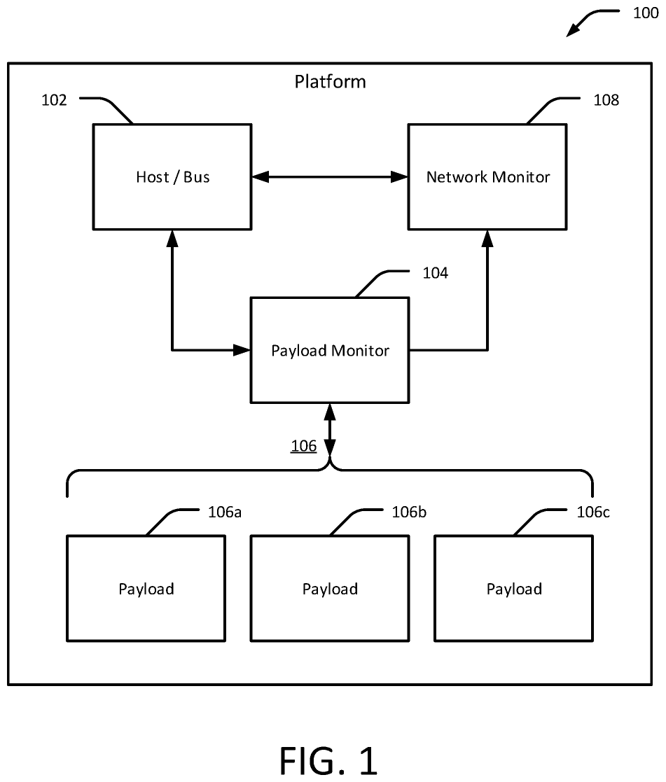

FIG. 1 is a block diagram of an example platform 100, in accordance with an embodiment of the present disclosure. The platform 100 can include, for example, a satellite, spacecraft, or any other type of vehicle. In some examples, the platform 100 can be stationary, such as a ground-based fixture, system, or testbed. The platform 100 includes a host/bus 102, a payload monitor 104, one or more payloads 106 (e.g., 106a, 106b, 106c, etc.), and a network monitor 108. The host/bus 102 is, in some examples, a SpaceWire communication network controller and communication bus, although it will be understood that other types of point-to-point or packet-switched communication networks can be used, such as RapidIO®. The payloads 106 are any systems or sub-systems of the platform 100 that are connected to, and communicate via, the host/bus 102. The payload monitor 104 is an intermediary that controls and manages network traffic between and across the host/bus 102 and the payloads 106, including data between payloads 106, up- and downlink traffic to and from the platform 100, radio frequency (RF) telemetry, or optical telemetry. The network monitor 108 is another intermediary that monitors and inspects the network traffic on the platform 100 for any anomalies by non-invasively tapping a SpaceWire physical link, interleaving the data stream from both endpoints, queuing the data stream in a buffer, and analyzing the data stream using a configurable detection algorithm. Upon detection of abnormal or malicious behavior in the data stream, the network monitor 108 notifies the host/bus 102, which can to respond to the behavior or download the data for further inspection and analysis. The monitor analysis algorithm is configurable through executable code uploaded from a trusted host platform.

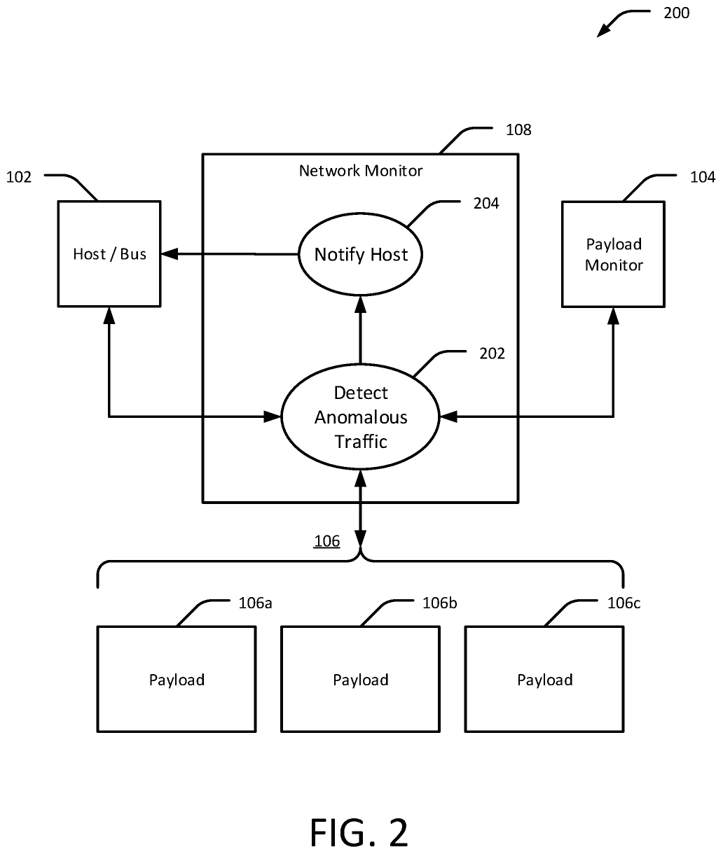

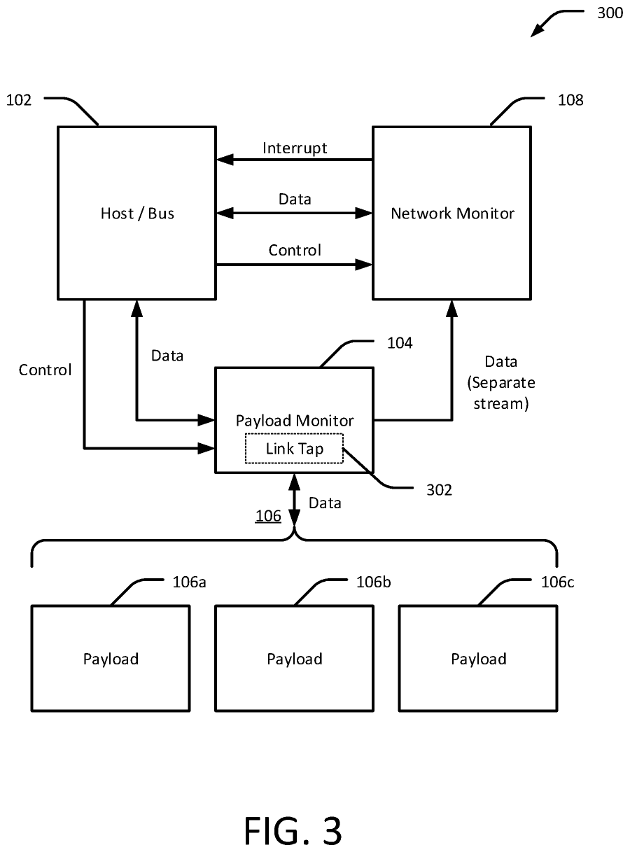

FIG. 2 is a logic flow diagram 200 representing an example use case for the network monitor 108, in accordance with an embodiment of the present disclosure. As noted above, the network monitor 108 monitors and inspects traffic crossing the communication network (e.g., SpaceWire) between and across the host/bus 102, the payload monitor 104, and the payloads 106. The network monitor 108 is configured to detect 202 anomalous traffic on the network and to notify 204 the host/bus 102 if anomalous traffic is detected, send the payload data to the host for further analysis, and/or to take another remedial action. Because at least some of the network traffic is point-to-point and asynchronous, it can be important to avoid any invasive traffic interruptions that could impair system operation (for example, by slowing, interfering with, or otherwise altering the data flow) or impede the ability to detect anomalous behavior in the system by otherwise modifying the data during inspection. To this end, in accordance with an embodiment and as discussed in further detail with respect to FIGS. 3-6, the network monitor 108 monitors and inspects a copy of the data in a non-invasive manner that permits anomalous traffic to be detected without interfering with normal network operations.

FIG. 3 is a data flow diagram 300 of an example operation of the system for detecting abnormal or malicious activity in a point-to-point or packet-switched data communication network, in accordance with an embodiment of the present disclosure. Data flows between the host/bus 102, the payload monitor 104, the payloads 106, and the network monitor 108. The host/bus 102 provides a control signal to the payload monitor 104 and the network monitor 108. The network monitor 108 provides an interrupt signal to the host/bus 102.

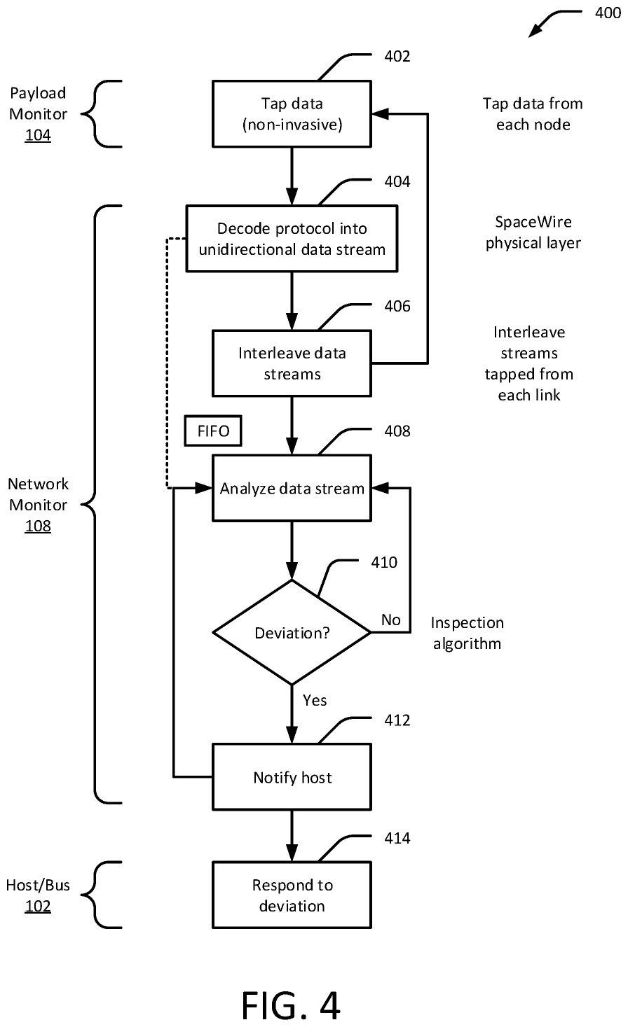

In operation, the host/bus 102 sends the control signal to the payload monitor 104 and the network monitor 108, indicating that communications to and/or from the payloads 106 are active. In response, the payload monitor activates a link tap 302. The link tap 302 creates a separate data stream to the network monitor 108 in parallel with the primary data stream between the host/bus 102 and the payloads 106. This is a non-invasive way to generate a separate, logical copy of the data for monitoring and inspection by the network monitor 108 without interfering with the normal flow of data between the host/bus 102 and the payloads 106. An example process for monitoring and inspecting the tapped data stream is described with respect to FIG. 4. Upon detecting abnormal or malicious activity, the network monitor 108 sends the interrupt signal to the host/bus 102, which triggers the host/bus 102 to respond to the activity and/or undertake further analysis of the data. For example, the host/bus 102 can respond by terminating the data stream or taking another action to mitigate the effect of the deviation.

### Example Methodology

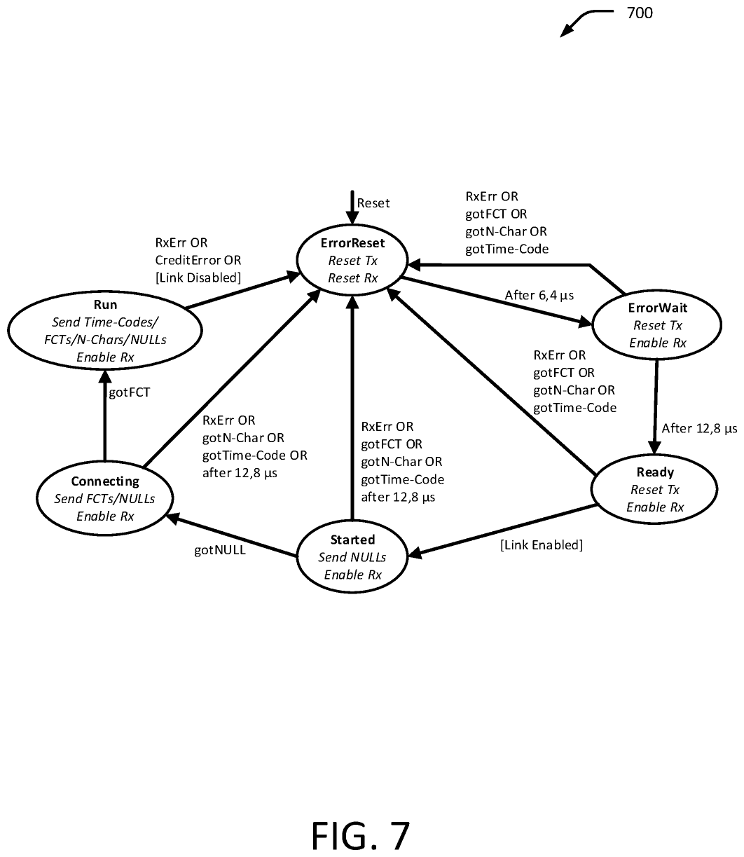

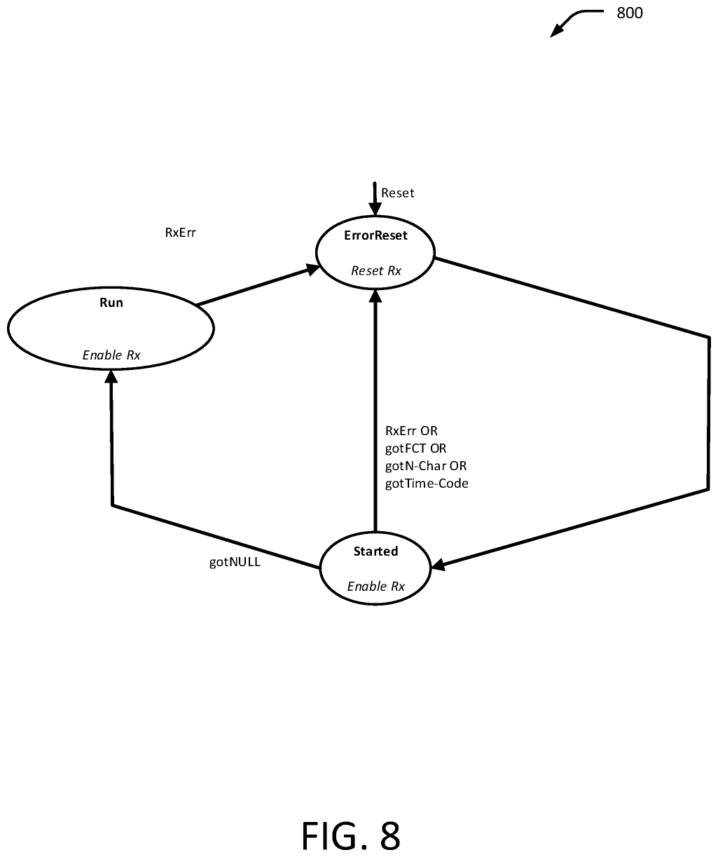

FIG. 4 is a flow diagram of an example method 400 for detecting abnormal or malicious activity in a point-to-point or packet-switched data communication network, in accordance with an embodiment of the present disclosure. The method 400 can be implemented, for example, on the platform 100 of FIG. 1, including the host/bus 102, the payload monitor 104, and the network monitor 108. In some embodiments, the method 400 can be initiated according to a state machine associated with the network, such as described with respect to FIGS. 7 and 8. For example, the method 400 can be initiated when the network is powered-on or otherwise reset to an initial operating state. In some examples, the network includes a SpaceWire or RapidIO® network.

The method 400 includes tapping 402 a link of the network non-invasively to obtain a data stream transmitted from a node of the network. In some examples, the data stream is a unidirectional data stream transmitted from one node of the network to another node in the network via the link. The data stream is tapped in parallel with transmission of the data stream through the network to create a logical copy of the original data stream. In this manner, the data stream is not interrupted or modified as it traverses the network. Using the logical copy of the data stream is like listening to, or inspecting, the network traffic rather than connecting to a network link to obtain the data stream, which can be invasive. In some embodiments, the tapping 402 is performed using a Low Voltage Differential Signaling (LVDS) component of the network.

The method 400 further includes decoding 404 a communication protocol encoded in the data stream to obtain payload data from the data stream. For example, if the network includes a SpaceWire network, then the data stream will be encoded according to the SpaceWire protocol at the physical layer of OSI model. Thus, the payload data can be obtained by decoding the SpaceWire protocol encoded in the data stream. Similarly, the payload data can be obtained by decoding the RapidIO® protocol encoded in the data stream of a RapidIO® network, or any other serialized communication network. The payload data is stored in a first-in, first-out (FIFO) buffer for subsequent processing.

In some embodiments, there can be multiple data streams transmitted from multiple nodes. The multiple streams may be transmitted, at least partly, at or about the same time such that each of the streams is traversing the network simultaneously. For example, a first node can transmit a first data stream and a second node can transmit a second data stream. In this case, the method 400 includes tapping 402 one or more links of the network to obtain the second data stream transmitted from the second node of the network in parallel with transmission of the second data stream through the network to create a logical copy of the second data stream in addition to the logical copy of the first data stream. The communication protocol encoded in the second data stream is decoded 404 to obtain second payload data from the second data stream. Next, the first payload data from the first data stream is interleaved 406 with the second payload data from the second data stream to obtain interleaved payload data. The interleaved payload data is stored in a first-in, first-out (FIFO) buffer for subsequent processing. It will be understood that any number of data streams can be tapped and interleaved in this manner.

The method 400 further includes analyzing 408 the payload data or the interleaved payload data in the FIFO to detect abnormal or malicious activity. The abnormal or malicious activity can be detected, for example, using a data processing algorithm that compares the payload data to expected or historical patterns of data in the network and identifies any deviations 410 from those data patterns. If no deviations are detected, the method 400 continues to analyze 408 the payload data in the FIFO. If a deviation is detected, the method 400 includes notifying 412 the host of the detected abnormal or malicious activity in the payload data, sending the payload data to the host for further analysis, and/or taking another remedial action. In some embodiments, the host can respond 414 to the deviation. For example, the host can respond by terminating the data stream or taking another action to mitigate the effect of the deviation. In some embodiments, the method 400 includes sending the payload data to the host for further analysis.

### Example Link Tap and Network Monitor

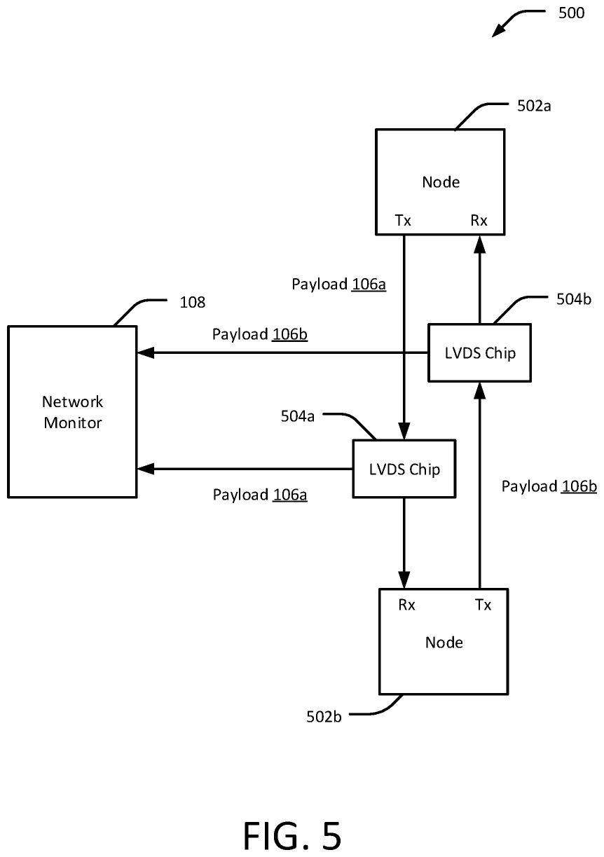

FIG. 5 is a block diagram of an example link tap 500, in accordance with an embodiment of the present disclosure. In this example, two nodes 502a and 504b in a data communication network, such as SpaceWire or RapidIO®, exchange payloads 106a and 106b, respectively. For example, node 502a transmits a unidirectional data stream to node 502b. The payload 106a is encoded in the unidirectional data stream according to the SpaceWire protocol. Similarly, node 502b transmits another unidirectional data stream to node 502a. The payload 106b is encoded in the unidirectional data stream according to the SpaceWire protocol. An LVDS chip 504a is used to tap the unidirectional data stream including the payload 106a and send a logical copy of the data stream to the network monitor 108. Another LVDS chip 504b is used to tap the unidirectional data stream including the payload 106b and send a logical copy of the data stream to the network monitor 108. In this manner, the normal flow of data between node 502a and node 502b is not interrupted. Such a tap is also referred to as an on-loop, or indirect, tap.

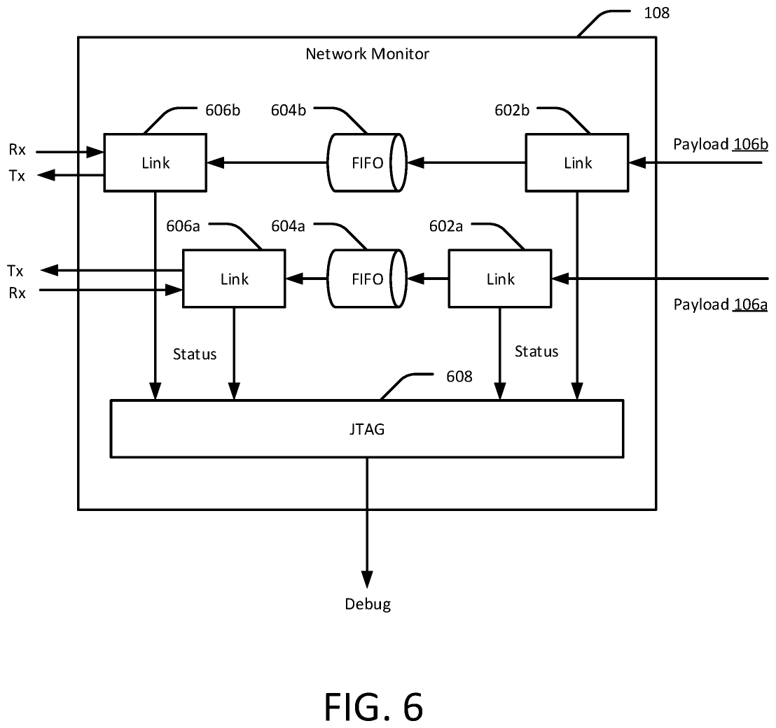

FIG. 6 is a block diagram of an example network monitor 108, in accordance with an embodiment of the present disclosure. In some embodiments, the network monitor 108 is configured to decode tapped data streams and convert the streams into a format that can be sent to a network (e.g., SpaceWire) link, whether the link is internal to the network monitor 108 or external, such as the host/bus 102. In some embodiments, the network monitor 108 can be implemented as an SEMC embedded microcontroller or a RISC V embedded microcontroller paired with a vector processor, which are configured to analyze network traffic, or other devices that are configured to analyze network traffic. As described with respect to FIG. 6, the network monitor 108 is configured to receive the payloads 106a, 106b. The network monitor 108 includes first links 602a, 602b, first and second FIFOs 604a, 604b, second links 606a, 606b, and a Joint Test Action Group (JTAG) serial communications interface 608. Each of the second links 606a, 606b are programmable and configurable to transmit and receive traffic to and from an internal network monitor processor 202 or an external system such as the host/bus 102. In some embodiments, the data processing algorithm 202, 408 compares the payload data or link data (for example, the link data can include protocol indicators that are used when raw payload data is encrypted or otherwise non-observable) to expected or historical patterns of data in the network and identifies any deviations from those data patterns from data supplied on the second links 606a, 606b. Link data includes data transferred on the SpaceWire link, exclusive of the actual payload data. For example, link data can include framing data, control codes, flow control tokens, time codes, markers, NULL characters, error codes, and other protocol data. The data processing algorithm 202, 408 detects certain anomalies or malicious behavior on the network based on the identified deviations.

In operation, the network monitor 108 receives the payloads 106a and 106b at the first and second links 602a, 602b. The first links 602a, 602b provide a status to the JTAG interface 608. The payloads 106a, 106b are fed into FIFOs 604a and 604b. In some embodiments, the payloads 106a, 106b can be interleaved and fed into a single FIFO. The output of the FIFOs 604a, 604b are fed into the second links 606a, 606b, respectively. To prevent overflow of the receive FIFO, the network includes circuitry to monitor the amount of space available in the receive FIFO and to regulate the data being sent from the other end using, for example, flow-control tokens. The second links 606a, 606b provide the tapped link or payload data 106a, 106b to the network analyzer 202,408 or external system such as host/bus 102. The second links 606a, 606b provide a status to the JTAG interface 608. The second links 606a, 606b also transmit and receive data to and from the network and can send the data to the host for further inspection and analysis by other algorithms. The JTAG interface 608 collects the status of the links 602a, 602b, 606a, and 606b. The JTAG interface 608 provides a debug signal, which can be used to monitor performance of the network monitor 108.

### Example State Machine

FIG. 7 is a flow diagram of an example state machine 700 representing operation of a SpaceWire network, in accordance with an embodiment of the present disclosure. The state machine is initiated with a Reset signal that causes the state machine to enter an ErrorReset State. The state machine then proceeds to an ErrorWait state. Under certain conditions, from the ErrorWait state, the state machine proceeds to a Ready state, then to a Started state, then to a Connecting State, then to a Run state, in which normal network operations (e.g., data streams transmitted and received between network nodes) occur. A SpaceWire network link can send and receive SpaceWire packets once it has been initialized and is running. Before a SpaceWire link can send and receive SpaceWire packets, the link needs to be initialized. This is done under control of the state machine 700. The state machine 700 also manages recovery from any errors detected on the link by re-initializing the link.

FIG. 8 is a flow diagram of an example state machine 800 representing operation of a method for non-invasively tapping a data communication network and analyzing a data stream to detect any anomalous or malicious activity, in accordance with an embodiment of the present disclosure. The state machine 800 is a modified version of the state machine 700 of FIG. 7. The state machine is initiated with a Reset signal that causes the state machine to enter an ErrorReset State. The state machine then proceeds a Started state, then to a Run state, in which normal network operations (e.g., data streams transmitted and received between network nodes) occur. In the Run state, a process, such as the method 400 of FIG. 4, executes to non-invasively tap the data communication network and analyze the data stream to detect any anomalous or malicious activity. By using the state machine 800, the process can operate in synchronization and in parallel with the normal network operations without interfering with or otherwise altering those operations or the state machine 700. Furthermore, because the state machine 800 is started by the same Reset signal as the state machine 700, the process for tapping and analyzing the network can operate independently of the network itself.

### Example Processing Platform

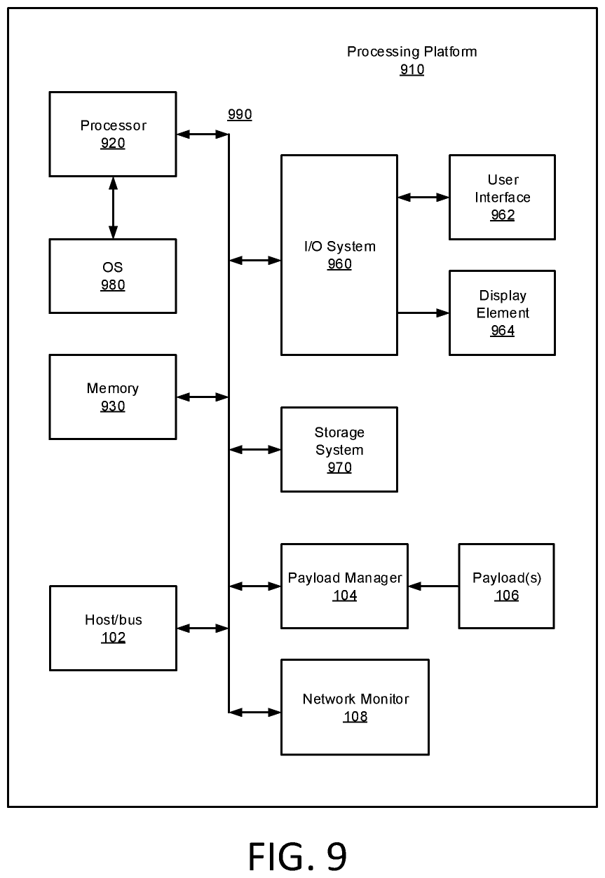

FIG. 9 is a block diagram of an example processing platform 910 that can be used in conjunction with the techniques as variously disclosed herein, in accordance with some embodiments of the present disclosure. In some embodiments, the platform 910, or portions thereof, may be hosted on, or otherwise be incorporated into a spacecraft, the electronic systems of the spacecraft, a ground station, or any other suitable platform.

In some embodiments, platform 910 may include any combination of a processor 920, a memory 930, an input/output (I/O) system 960, a user interface 962, a display element 964, a storage system 970, the host/bus 102, the payload monitor 104, and/or the network monitor 108. As can be further seen, a bus and/or interconnect 990 is also provided for communication between the various components listed above and/or other components not shown. Other componentry and functionality not reflected in the block diagram of FIG. 9 will be apparent in light of this disclosure, and it will be appreciated that other embodiments are not limited to any particular hardware configuration.

Processor 920 can be any suitable processor, and may include one or more coprocessors or controllers, such as an audio processor, a graphics processing unit, or hardware accelerator, to assist in control and processing operations associated with platform 910. In some embodiments, the processor 920 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 920 may be implemented as a complex instruction set computer (CISC) or a reduced instruction set computer (RISC) processor.

Memory 930 can be implemented using any suitable type of digital storage including, for example, flash memory and/or random-access memory (RAM). In some embodiments, the memory 930 may include various layers of memory hierarchy and/or memory caches as are known to those of skill in the art. Memory 930 may be implemented as a volatile memory device such as, but not limited to, a RAM, dynamic RAM (DRAM), or static RAM (SRAM) device. Storage system 970 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 920 may be configured to execute an Operating System (OS) 980 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with platform 910, and therefore may also be implemented using any suitable existing or subsequently-developed platform.

I/O system 960 may be configured to interface between various I/O devices and other components of platform 910. I/O devices may include, but not be limited to, user interface 962 and display element 964. User interface 962 may include other devices (not shown) such as a touchpad, keyboard, mouse, microphone and speaker, trackball or scratch pad, and camera. I/O system 960 may include a graphics subsystem configured to perform processing of images for rendering on the display element 964. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 920 or any chipset of platform 910.

It will be appreciated that in some embodiments, some of the various components of platform 910 may be combined or integrated in a system-on-a-chip (SoC) architecture. In some embodiments, the components may be hardware components, firmware components, software components or any suitable combination of hardware, firmware or software.

The host/bus 102, the payload monitor 104, and/or the network monitor 108 are configured to perform a method of detecting abnormal or malicious activity in a point-to-point or packet-switched data communication network, as described previously. The host/bus 102, the payload monitor 104, and/or the network monitor 108 may include any or all of the circuits/components illustrated in FIGS. 1-3, 5 and 6, as described above. These components can be implemented or otherwise used in conjunction with a variety of suitable software and/or hardware that is coupled to or that otherwise forms a part of platform 910. These components can additionally or alternatively be implemented or otherwise used in conjunction with user I/O devices that are capable of providing information to, and receiving information and commands from, a user.

Various embodiments of platform 910 may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, causes one or more of the methodologies disclosed herein to be implemented. Other componentry and functionality not reflected in the illustrations will be apparent in light of this disclosure, and it will be appreciated that other embodiments are not limited to any particular hardware or software configuration. Thus, in other embodiments platform 910 may comprise additional, fewer, or alternative subcomponents as compared to those included in the example embodiment of FIG. 9.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). In some embodiments, the hardware may be modeled or developed using hardware description languages such as, for example Verilog or VHDL. Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The disclosure is not intended to be limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, or one or more embedded routines configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads or parallel processes in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), computers, and other processor-based or functional systems. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the example embodiments. It will be understood by an ordinarily-skilled artisan, however, that variations of the example embodiments may be practiced without these specific details. In other instances, well known operations, components and circuits have not been described in detail so as not to obscure the example embodiments. It can be appreciated that the specific structural and functional details disclosed herein representative of numerous alternative embodiments and configurations and are not intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Additional Examples

Numerous embodiments will be apparent in light of the present disclosure, and features described herein can be combined in any number of configurations.

Example 1 provides a computer program product including one or more non-transitory machine-readable mediums encoded with instructions that when executed by one or more processors cause a process to be carried out for detecting abnormal or malicious activity in a point-to-point or packet-switched data communication network. The process includes tapping a link in the network to obtain a separate, logical copy of a data stream transmitted from a node of the network in parallel with transmission of the data stream through the network; decoding a communication protocol encoded in the logical copy of the data stream to obtain payload or link data from the data stream; analyzing the payload or link data to detect abnormal or malicious activity; and in response to detecting abnormal or malicious activity, initiating a remedial action.

Example 2 includes the subject matter of Example 1, where the node is a first node, where the data stream is a first data stream, where the payload or link data is first payload or link data, and where the process includes tapping the link in the network to obtain a separate, logical copy of a second data stream transmitted from a second node of the network in parallel with transmission of the second data stream through the network; decoding the communication protocol encoded in the logical copy of the second data stream to obtain second payload or link data from the second data stream; and analyzing the first payload or link data and the second payload or link data to detect the abnormal or malicious activity.

Example 3 includes the subject matter of Example 2, where the process further includes interleaving the first payload or link data from the logical copy of the first data stream with the second payload or link data from the logical copy of the second data stream to obtain interleaved payload or link data; and analyzing the interleaved payload or link data to detect the abnormal or malicious activity.

Example 4 includes the subject matter of any of Examples 1-3, where initiating remedial action includes notifying a host of the network of the detected abnormal or malicious activity in the payload or link data, and where the process further includes causing the host to respond to the notification of the detected abnormal or malicious activity.

Example 5 includes the subject matter of any of Examples 1-4, where the process further includes storing the payload or link data in a First-in, first-out (FIFO) buffer or other storage device.

Example 6 includes the subject matter of any of Examples 1-5, where initiating remedial action includes sending the payload or link data to the host for further analysis.

Example 7 includes the subject matter of any of Examples 1-6, where the tapping is carried out using a Low Voltage Differential Signaling (LVDS) component of the network.

Example 8 includes the subject matter of any of Examples 1-7, where the tapping includes tapping a physical layer of the network to obtain the data stream.

Example 9 includes the subject matter of any of Examples 1-8, where the network includes a SpaceWire network.

Example 10 provides a system for detecting abnormal or malicious activity in a point-to-point or packet-switched data communication network, the system including a payload monitor configured to tap a link in the network to obtain a separate, logical copy of a data stream transmitted from a node of the network in parallel with transmission of the data stream through the network; and a network monitor configured to: decode a communication protocol encoded in the logical copy of the data stream to obtain payload or link data from the data stream; analyze the payload or link data to detect abnormal or malicious activity; and notify a host of the network of the detected abnormal or malicious activity in the payload or link data.

Example 11 includes the subject matter of Example 10, where the node is a first node; the data stream is a first data stream; the payload or link data is first payload or link data; the payload monitor is further configured to tap the link in the network to obtain a separate, logical copy of a second data stream transmitted from a second node of the network in parallel with transmission of the second data stream through the network; and the network monitor is further configured to: decode the communication protocol encoded in the logical copy of the second data stream to obtain second payload or link data from the second data stream; and analyze the first payload or link data and the second payload or link data to detect the abnormal or malicious activity.

Example 12 includes the subject matter of Example 11, where the network monitor is further configured to interleave the first payload or link data from the logical copy of the first data stream with the second payload or link data from the logical copy of the second data stream to obtain interleaved payload or link data; and analyze the interleaved payload or link data to detect the abnormal or malicious activity.

Example 13 includes the subject matter of any of Examples 10-12, where the network monitor is further configured to cause the host to respond to the notification of the detected abnormal or malicious activity.

Example 14 includes the subject matter of any of Examples 10-13, including a First-in, first-out (FIFO) buffer or other storage device configured to store the payload or link data.

Example 15 includes the subject matter of any of Examples 10-14, where the network monitor is further configured to send the payload or link data to the host for further analysis.

Example 16 includes the subject matter of any of Examples 10-15, including a Low

Voltage Differential Signaling (LVDS) component configured to tap the network.

Example 17 includes the subject matter of any of Examples 10-16, where the payload monitor is further configured to tap a physical layer of the network to obtain the data stream.

Example 18 includes the subject matter of any of Examples 10-17, where the network includes a SpaceWire network.

Example 19 provides a system for detecting abnormal or malicious activity in a SpaceWire network, the system including a memory; and one or more processors in communication with the memory, the one or more processors configured to execute instructions stored in the memory to: decode a communication protocol encoded in a data stream transmitted from a node of the SpaceWire network to obtain payload or link data from a separate, logical copy of the data stream; analyze the payload or link data to detect abnormal or malicious activity; and notify a host of the SpaceWire network of the detected abnormal or malicious activity in the payload or link data.

Example 20 includes the subject matter of Example 19, where the one or more processors are further configured to execute instructions stored in the memory to tap a link in the SpaceWire network to obtain the logical copy of the data stream transmitted from the node of the SpaceWire network in parallel with transmission of the data stream through the SpaceWire network.

Example 21 includes the subject matter of any of Examples 19-20, where the one or more processors are further configured to execute instructions stored in the memory to cause the host to respond to the notification of the detected abnormal or malicious activity.

Example 22 includes the subject matter of any of Examples 19-21, including a Low Voltage Differential Signaling (LVDS) component configured to tap the SpaceWire network.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A computer program product including one or more non-transitory machine-readable mediums encoded with instructions that when executed by one or more processors cause a process to be carried out for detecting abnormal or malicious activity in a point-to-point or packet-switched data communication network, the process comprising:
tapping a link in the network to obtain a separate, logical copy of a data stream transmitted from a node of the network in parallel with transmission of the data stream through the network;
decoding a communication protocol encoded in the logical copy of the data stream to obtain payload or link data from the data stream;
analyzing the payload data to detect abnormal or malicious activity; and
in response to detecting abnormal or malicious activity, initiating a remedial action.

2. The computer program product of claim 1, wherein the node is a first node, wherein the data stream is a first data stream, wherein the payload or link data is first payload or link data, and wherein the process further comprises:
tapping the link in the network to obtain a separate, logical copy of a second data stream transmitted from a second node of the network in parallel with transmission of the second data stream through the network;
decoding the communication protocol encoded in the logical copy of the second data stream to obtain second payload or link data from the second data stream; and
analyzing the first payload or link data and the second payload or link data to detect the abnormal or malicious activity.

3. The computer program product of claim 2, further comprising:
interleaving the first payload or link data from the logical copy of the first data stream with the second payload or link data from the logical copy of the second data stream to obtain interleaved payload or link data; and
analyzing the interleaved payload or link data to detect the abnormal or malicious activity.

4. The computer program product of claim 1, wherein initiating remedial action includes notifying a host of the network of the detected abnormal or malicious activity in the payload or link data, and wherein the process further comprises causing the host to respond to the notification of the detected abnormal or malicious activity.

5. The computer program product of claim 1, wherein the process further comprises storing the payload or link data in a First-in, first-out (FIFO) buffer or other storage device.

6. The computer program product of claim 1, wherein initiating remedial action includes sending the payload or link data to the host for further analysis.

7. The computer program product of claim 1, wherein the tapping is carried out using a Low Voltage Differential Signaling (LVDS) component of the network.

8. The computer program product of claim 1, wherein the tapping includes tapping a physical layer of the network to obtain the data stream.

9. A system for detecting abnormal or malicious activity in a point-to-point or packet-switched data communication network, the system comprising:
a payload monitor configured to tap a link in the network to obtain a separate, logical copy of a data stream transmitted from a node of the network in parallel with transmission of the data stream through the network; and
a network monitor configured to:
decode a communication protocol encoded in the logical copy of the data stream to obtain payload or link data from the data stream;
analyze the payload or link data to detect abnormal or malicious activity; and
notify a host of the network of the detected abnormal or malicious activity in the payload or link data.

10. The system of claim 9, wherein:
the node is a first node;
the data stream is a first data stream;
the payload or link data is first payload or link data;
the payload monitor is further configured to tap the link in the network to obtain a separate, logical copy of a second data stream transmitted from a second node of the network in parallel with transmission of the second data stream through the network; and
the network monitor is further configured to
decode the communication protocol encoded in the logical copy of the second data stream to obtain second payload or link data from the second data stream;
and
analyze the first payload or link data and the second payload or link data to detect the abnormal or malicious activity.

11. The system of claim 1, wherein the network monitor is further configured to:
interleave the first payload or link data from the logical copy of the first data stream with the second payload or link data from the logical copy of the second data stream to obtain interleaved payload or link data; and
analyze the interleaved payload or link data to detect the abnormal or malicious activity.

12. The system of claim 9, wherein the network monitor is further configured to cause the host to respond to the notification of the detected abnormal or malicious activity.

13. The system of claim 9, further comprising a First-in, first-out (FIFO) buffer or other storage device configured to store the payload or link data.

14. The system of claim 9, wherein the network monitor is further configured to send the payload or link data to the host for further analysis.

15. The system of claim 9, further comprising a Low Voltage Differential Signaling (LVDS) component configured to tap the network.

16. The system of claim 9, wherein the payload monitor is further configured to tap a physical layer of the network to obtain the data stream.

17. A system for detecting abnormal or malicious activity in a SpaceWire network, the system comprising:
a memory; and
one or more processors in communication with the memory, the one or more processors configured to execute instructions stored in the memory to:
decode a communication protocol encoded in a data stream transmitted from a node of the SpaceWire network to obtain payload or link data from a separate, logical copy of the data stream;
analyze the payload or link data to detect abnormal or malicious activity; and
notify a host of the SpaceWire network of the detected abnormal or malicious activity in the payload or link data.

18. The system of claim 17, wherein the one or more processors are further configured to execute instructions stored in the memory to tap a link in the SpaceWire network to obtain the logical copy of the data stream transmitted from the node of the SpaceWire network in parallel with transmission of the data stream through the SpaceWire network.

19. The system of claim 17, wherein the one or more processors are further configured to execute instructions stored in the memory to cause the host to respond to the notification of the detected abnormal or malicious activity.

20. The system of claim 17, further comprising a Low Voltage Differential Signaling (LVDS) component configured to tap the SpaceWire network.
